(19) United States
(12) Patent Application Publication
(10) Pub. No.: US 2025/0305641 A1
(43) Pub. Date: Oct. 2, 2025

(54) Rupture-Resistant Containment Fill Station

(71) Applicant: ARCTIC COMPRESSOR, LLC, Superior, WI (US)

(72) Inventors: Steven Potter, Superior, WI (US); Eric Nistler, Superior, WI (US); Stephen Talaga, Superior, WI (US); Pat Byrne, Superior, WI (US)

(21) Appl. No.: 18/623,754

(22) Filed: Apr. 1, 2024

(51) Int. Cl. F17C 13/12

(52) U.S. Cl. CPC F17C 13/123; F17C 2201/0109; F17C 2201/032; F17C 2205/0111; F17C 2205/013; F17C 2223/035; F17C 2260/042

(57) ABSTRACT

A lightweight high pressure cylinder containment fill station comprising: a containment housing; and cylinder tubes; wherein the containment housing is configured to substantially enclose the cylinder tubes; wherein the cylinder tubes comprise composite materials; wherein each cylinder tube is configured to retain a pressurized cylinder; wherein each cylinder tube is configured to substantially absorb a force from the pressurized cylinder when the pressurized cylinder ruptures; wherein an unabsorbed force, from when the pressurized cylinder ruptures, vents out of the cylinder tubes as a residual reduced force; and wherein the containment housing is configured to substantially absorb and retain the residual reduced force.

### FIELD OF USE

The present disclosure relates, in general, to a lightweight rupture-resistant containment fill station. More specifically, the present disclosure relates to a lightweight rupture-resistant containment fill station designed to protect a compressed air tank filling operator from a tank rupture while filling the tank with compressed gas.

### BACKGROUND

Generally, compressed gas containers, such as compressed gas cylinders, may be refillable or non-refillable (one time use). Although not refillable, the one-time use gas cylinder is still, at one point, filled. Whether an initial fill or a refill, the dangers of filling compressed gas containers are the same.

Compressed gas cylinders fail for many different reasons, and when they fail, they fail with a destructive force capable of inflicting serious harm or even death to any nearby persons.

A containment fill station for gas cylinders is a system or area that is designed to safely allow a user to fill or re-fill empty storage containers, such as gas cylinders, with pressurized fluid. The containment is provided by metal plates that are designed to contain any blasts or ruptures that happen during the filling process. Typical compressed gas cylinder fill stations are very bulky and made of heavy metal plating to absorb projectiles, destructive forces, or even flying cylinders that may be caused by the explosive force of a ruptured compressed gas cylinder. Because the compressed gas cylinders themselves are bulky and heavy, it is advantageous for them to be filled in a separate room or building and are not, generally, mobile or convenient for all purposes. Although the cylinders are bulky and heavy, they are much more mobile than the fill stations that fill them, so extra cylinders are frequently transported during an operation, rather than making the fill station more convenient.

Thus, what is needed is a fill station capable of being transported to remote locations while providing the safety-related features of traditional compressed gas fill stations.

### SUMMARY

To minimize the limitations in the prior art, and to minimize other limitations that will become apparent upon reading and understanding the present specification, the present disclosure discloses a new and useful lightweight rupture-resistant containment fill station.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with containment fill stations for high-pressure gas cylinders before the present disclosure is that they are made from heavy metal materials, which allows the fill station to safely contain a rupture or failure of a high-pressure cylinder during filling. This makes use or placement of fill stations in remote locations, generally, impractical. To solve this problem, the device and method of the present disclosure may incorporate several lightweight composite materials and design features that allow the replacement of heavy metal materials, thereby reducing the size and weight of a fill station, but without compromising safety.

One embodiment of the present disclosure may be a composite containment fill station that comprises a containment housing, one or more cylinder tubes, and one or more composite material crumple zones, which are operatively situated to absorb any and all force from a ruptured pressurized cylinder. The cylinder tubes may absorb most, if not all, of the force released by a ruptured pressurized cylinder by allowing the composite materials to take the brunt of the force and break down in an organized or planned manner. Any residual force or objects/projectiles that escape the tubes during a rupture may further be absorbed by the containment fill station housing that may also have one or more composite material crumple zones.

One embodiment of the present disclosure may be a lightweight high pressure cylinder containment fill station comprising: a containment housing; and cylinder tubes; wherein the containment housing may be configured to substantially enclose the cylinder tubes; wherein the cylinder tubes comprise composite materials; wherein each of the cylinder tubes may be configured to retain a pressurized cylinder; wherein each of the cylinder tubes may be configured to substantially absorb a force from the pressurized cylinder when the pressurized cylinder ruptures; wherein an unabsorbed force, from when the pressurized cylinder ruptures, vents out of the cylinder tubes as a residual reduced force; and wherein the containment housing may be configured to substantially absorb and retain the residual reduced force. the containment housing may comprise a metal material and composite materials. The containment housing and the cylinder tubes may be made from materials selected from the group of materials consisting of: composite materials; plastics; polyethylene; polycarbonate; acrylonitrile butadiene styrene polyphenylsulfone; ultra-high molecular weight polyethylene; thin and lightweight metal materials; heavy metal materials; fiber composites; fiberglass; aramid fibers; para-aramid fibers; polyurethane-foamed aluminum; plywood, composite laminates; and/or synthetic viscoelastic urethane polymer. The fill station may further comprise a pivot point, wherein the cylinder tubes may be configured to rotate about the pivot point, such that the cylinder tubes have an enclosed position and a loading position. The cylinder tubes may be configured to accept installation of the pressurized cylinders, when the cylinder tubes are in the loading position. The cylinder tubes may be configured to structurally breakdown while absorbing the force from the pressurized cylinder when the pressurized cylinder ruptures. Each of the cylinder tubes may further comprise: filament fibers, wherein the filament fibers may be wound around the composite materials of each of the cylinder tubes. The filament fibers may be selected from the group of filament fibers consisting of: glass; carbon; aramid; and/or combinations thereof. The containment housing may further comprise: crumple zone structures, which may be configured to deform as they absorb any portion of the residual reduced force from the pressurized cylinder when the pressurized cylinder ruptures. The containment housing may further comprise: a pressurized cylinder installation opening, wherein when the cylinder tubes are in the loading position, the cylinder tubes may be configured to be accessible through the pressurized cylinder installation opening. The pressurized cylinder installation opening may be configured to allow any unabsorbed residual reduce force of the ruptured pressurized cylinder to vent in a controlled manner out of the containment housing. Each of the crumple zone structures may comprise materials selected from the group of materials comprising: plastics; plastic composites; carbon fiber; honeycomb or corrugated cardboard; plywood; and/or energy-absorbing foam.

Another embodiment may be a lightweight high pressure cylinder containment fill station comprising: a containment housing; a pivot point; and cylinder tubes; wherein the containment housing may be configured to substantially enclose the cylinder tubes; wherein the cylinder tubes comprise composite materials; wherein each of the cylinder tubes may be configured to retain a pressurized cylinder; wherein each of the cylinder tubes may be configured to substantially absorb a force from the pressurized cylinder when the pressurized cylinder ruptures; wherein an unabsorbed force, from when the pressurized cylinder ruptures, vents out of the cylinder tubes as a residual reduced force; wherein the containment housing may be configured to substantially absorb and retain the residual reduced force; wherein the cylinder tubes may be configured to rotate about the pivot point, such that the cylinder tubes have an enclosed position and a loading position; and wherein the cylinder tubes may be configured to accept installation of the pressurized cylinders, when the cylinder tubes may be in the loading position. The containment housing and the cylinder tubes may be made from materials selected from the group of materials consisting of: composite materials; plastics; polyethylene; polycarbonate; acrylonitrile butadiene styrene polyphenylsulfone; ultra-high molecular weight polyethylene; thin and lightweight metal materials; heavy metal materials; fiber composites; fiberglass; aramid fibers; para-aramid fibers; polyurethane-foamed aluminum; plywood, composite laminates; and/or synthetic viscoelastic urethane polymer. The cylinder tubes may be configured to structurally breakdown while absorbing the force from the pressurized cylinder when the pressurized cylinder ruptures. Wherein each of the cylinder tubes further comprises: filament fibers; wherein the filament fibers may be wound around the composite materials of each of the cylinder tubes; and wherein the filament fibers may be selected from the group of filament fibers consisting of: glass; carbon; aramid; and combinations thereof. The containment housing may further comprise: crumple zone structures, which may be configured to deform as they absorb any portion of the residual reduced force from the pressurized cylinder when the pressurized cylinder ruptures. Each of the crumple zone structures may comprise materials selected from the group of materials consisting of: plastics; plastic composites; carbon fiber; honeycomb or corrugated cardboard; plywood; and/or energy-absorbing foam. The containment housing may further comprise: a pressurized cylinder installation opening. When the cylinder tubes are in the loading position, the cylinder tubes may be configured to be accessible through the pressurized cylinder installation opening. The pressurized cylinder installation opening may be configured to allow any unabsorbed residual reduced force of the ruptured pressurized cylinder to vent in a controlled manner out of the containment housing.

Another embodiment might be a lightweight high pressure cylinder containment fill station comprising: a containment housing; an impact absorbing insert (“IAI”); wherein the containment housing may be configured to substantially enclose the IAI; wherein the IAI comprises composite materials; wherein the IAI may be configured to retain at least one pressurized cylinder; wherein the IAI may be configured to substantially absorb a force from the at least one pressurized cylinder when the pressurized cylinder ruptures; wherein an unabsorbed force, from when the at least one pressurized cylinder ruptures, vents out of the IAI as a residual reduced force; and wherein the containment housing may be configured to substantially absorb and retain the residual reduced force. The IAI may be at least partially removed from the containment housing, such that the IAI has an enclosed position and a loading position; and wherein the IAI may be configured to accept installation of the at least one pressurized cylinder, when the IAI may be in the loading position. The IAI may be configured to structurally breakdown while absorbing the force from the at least one pressurized cylinder when the at least one pressurized cylinder ruptures. The IAI may further comprise filament fibers, which may be wound around the composite materials of the IAT. The filament fibers may be selected from the group of filament fibers consisting of: glass; carbon; aramid; and/or combinations thereof. The containment housing further comprises a crumple zone structures, which may be configured to deform as they absorb any portion of the residual reduced force from the at least one pressurized cylinder when the at least one pressurized cylinder ruptures. Each of the crumple zone structures may comprise materials selected from the group of materials consisting of: plastics; plastic composites; carbon fiber; honeycomb or corrugated cardboard; plywood; and/or energy-absorbing foam.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a perspective view of one embodiment of a rupture-resistant containment fill station.

FIG. 2 is an illustration of a side cross-sectional view of one embodiment of the rupture-resistant containment fill station.

FIG. 3 is an illustration of a front view of one embodiment of the rupture-resistant containment fill station.

FIG. 4 is an illustration of side view of one embodiment of the rupture-resistant containment fill station.

FIG. 5 is an illustration of a perspective view of another embodiment of a rupture-resistant containment fill station.

FIG. 6 is an illustration of an exploded view of another embodiment of a rupture-resistant containment fill station.

FIG. 7 is an illustration of a front view of another embodiment of the rupture-resistant containment fill station.

FIG. 8 is an illustration of a side view of another embodiment of the rupture-resistant containment fill station.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-40% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

As used herein, the term “absorb” refers to the elastic deformation, deformation, or fracture/comminution of a material due to kinetic mechanical energy.

As used herein, the term “composite” or “composite materials” refers to a combination of two or more constituent materials with different physical or chemical properties. Combined, they produce a material with characteristics different from their original properties. Examples of composite materials include rebar reinforced concrete/stone, plywood, fiber-reinforced polymers, fiberglass, ceramic matrix composites, which are composite ceramic and metal matrices, metal matrix composites, and advanced composite materials (which combine resin, curing agents, and/or fibers, such as fiberglass).

As used herein, the term “containment housing” refers to containers designed to safely secure, transport, and fill pressurized cylinders.

As used herein, the term “crumple” refers to a volume, mass, or shape that is pressed, compacted, crushed, or bent into irregular, but somewhat predictable, folds, shapes, wrinkles, or collapsed shapes.

As used herein, the term “crumple zone” refers to a structural safety feature that is designed to crumple or crush upon having a force applied to it.

As used herein, the term “cylinder tube(s)” refers to a container(s) to retain inserted cylinders.

As used herein, the term “mechanic force” or “force” refers to a direct interface between two items that results in a modification in the object's condition.

As used herein, the term “force from a pressurized cylinder” refers to a mechanical force a pressurized cylinder releases when it ruptures or unexpectedly releases pressure.

As used herein, the term “house” or “housing” refers to a protective casing designed to enclose cylindrical tubes, cylinders, compressed gas containers, and associated cylinder-filling equipment

As used herein, the term “pressurized cylinder”. “compressed gas container”, and “compressed gas cylinder”, refer to a vessel that stores and transports gases at pressures above atmospheric.

As used herein, the term pressurized cylinder “failure” refers to a pressurized cylinder's inability to maintain pressure due to failures such as rupture, seal failure, side loading, mount connection failure, Extreme temperatures, and corrosion. Failures can be instantaneous or slow and delayed release of pressure failures.

As used herein, the term “residual” refers to the difference between the initially released force of a ruptured pressurized cylinder and the force absorbed by a force-absorbing feature.

As used herein, the term “retain” refers to the holding and securing of a pressurized cylinder as it is filled.

As used herein, the term “rupture” or “pressurized cylinder rupture” refers to the sudden break or burst of a pressurized cylinder wall.

As used herein, the term “unabsorbed” refers to any mechanical force that remains to be absorbed by a force-absorbing feature.

As used herein, the term “void volume” refers to the volume of a cylinder tube designed to retain a pressurized cylinder.

As used herein, the term “winding” refers to the act of configuring a material in a spiral manner.

The rupture-resistant containment fill station of the present disclosure may be a device, system, and/or method of absorbing a force released during the filing of pressurized cylinders that incorporates lightweight composite materials and design features that allow the replacement of the heavy metal materials thereby allowing a reduction in size and weight of a fill station.

One embodiment of the present disclosure may comprise a containment housing, one or more cylinder tubes, and crumple zones, which may be configured or situated to absorb any and all forces, shrapnel, or partial cylinders, from a ruptured pressurized fluid cylinder. The cylinder tubes may absorb the majority of the force released by allowing the composite materials to break down. Any residual force or objects that escape cylinder tubes during a rupture may further be absorbed by the containment housing that may also have crumple zones.

Self-contained breathing apparatus (SCBA) cylinders and a scuba tank are containers or vessels for pressurized gas used in breathing devices such as scuba and self-contained breathing apparatuses. SCBA cylinders and scuba tanks are typically fillable and designed for multiple uses. Because of the high pressures involved when filling SCBA cylinders and scuba tanks, they are susceptible to dangerous and catastrophic failures.

It should be understood that disclosure is not limited to SCBA and scuba-type pressurized cylinder tanks. All types of pressurized gas containers or cylinders may be used in the fill stations of the present disclosure.

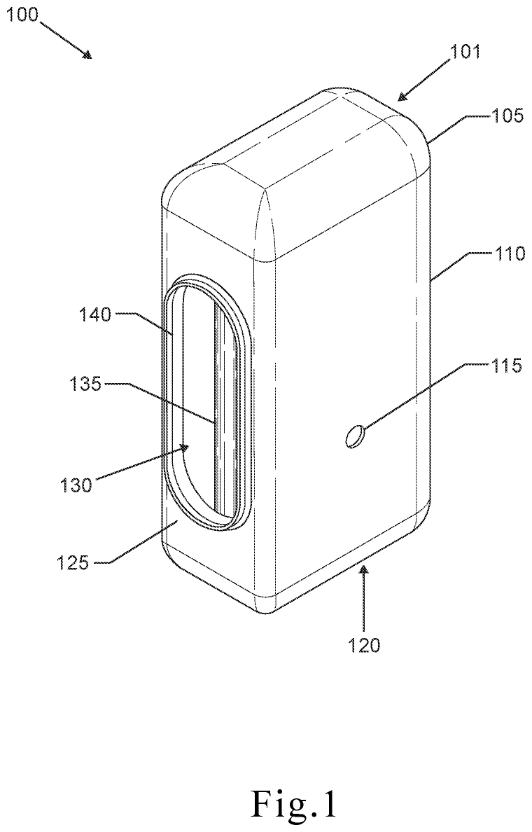

FIG. 1 is an illustration of a perspective view of one embodiment of a rupture-resistant containment fill station. As shown in FIG. 1, rupture-resistant containment fill station 100 may comprise containment housing 101, pivot point 115, installation aperture 130, and one or more cylinder tubes 135.

Pivot point 115 may be any mechanism that may provide a rupture-resistant containment fill station 100 operator with the ability to pivot the cylinder tubes 135 from being substantially being enclosed within housing 101 (during a fill cycle) or only partially contained within housing 101 when loading or unloading the cylinders into the station 100 which may also be referred to as the loading position.

Containment housing 101 may further comprise external top structure 105, external right structure wall 110, external bottom structure 120, external left structure wall 125, and installation rim or opening structure 140. Containment housing 101 may preferably be constructed to support various internal structures, features, and accessories. Opening structure 140 may be configured to allow the installation (loading or unloading) of one or more cylinders and may allow any force not absorbed internally to vent or escape without compromising the containment housing structure through installation aperture 130. Preferably, containment housing 101 may be constructed using lightweight and strong materials, such as thinned steel plating or reinforcement, aluminum, and/or composite materials, but it may be made from any suitable material that provides strength and lightweight. The strength of a material may be compromised when manufactured using thinner dimensions, so care must be taken to place thicker plating or stronger composite materials in places where strength is needed the most.

In various embodiments, containment housing 101 may be a single unit or, as preferred, may be constructed from multiple interconnected portions, wherein each of the portions may be of a different or specific type of material. Containment housing 101 and the other components of rupture-resistant containment fill station 100, including external top structure 105, external right structure wall 110, external bottom structure 120, external left structure wall 125, and installation opening structure 140 may be made using injection mold techniques, welding metals, or being formed via other known manufacturing techniques. Additionally, any one of these portions may be, may partially be, or may have crumple zones that may be made from composite materials. As shown in FIG. 1, rupture-resistant containment fill station 100 may generally be a rounded rectangular shape. It should be understood that rupture-resistant containment fill station 100 may be any shape, including, but not limited to, square, hexagonal, or other geometric shape, or cylindrical.

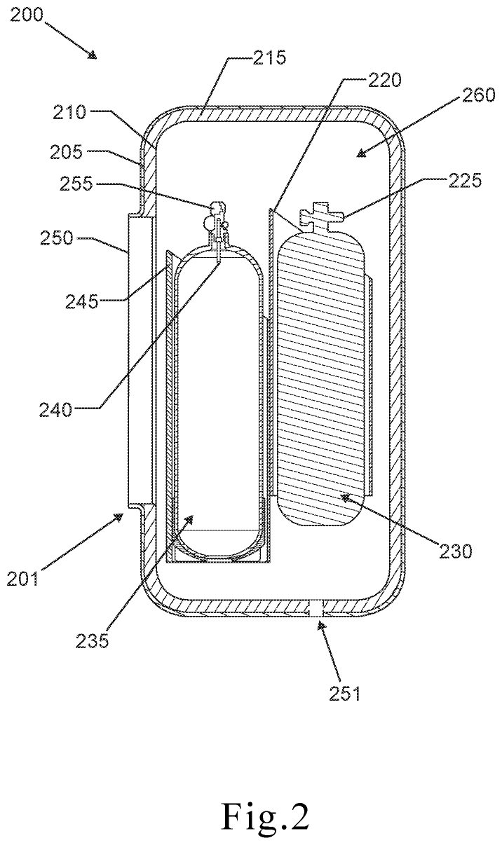

FIG. 2 is an illustration of a side cross-sectional view of one embodiment of the rupture-resistant containment fill station. In the configuration shown in FIG. 2, pressurized cylinders such as but not limited to SCBA cylinder 230 and scuba tank 235 may be loaded into fill station 200 and then filled with pressurized fluid. The rupture-resistant containment fill station 200 may comprise containment housing 201, cylinder #1 tube structure 220, SCBA cylinder valve 225, SCBA cylinder 230, scuba tank 235, dip tube 240, cylinder #2 tube structure 245, scuba tank valve 255, and gas expansion volume 260. Containment housing 201 may comprise exterior wall structure 205, interior wall structure 210, crumple zone structure 215, air blast vent 251, and opening structure 250.

It may be preferable that exterior wall structure 205, interior wall structure 210, crumple zone structure 215, air blast vent 251, and opening structure 250 all may be in mechanical communication and situated in such a way as to absorb and transfer any rupture or explosive forces properly and/or diffusely.

Containment housing 201 preferably and substantially encloses cylinder #1 tube structure 220 and cylinder #2 tube structure 245, as shown in FIG. 2, such that most force from a pressurized cylinder is absorbed when a pressurized cylinder ruptures. Because containment housing 201 substantially encloses cylinder #1 tube structure 220 and cylinder #2 tube structure 245 and does not completely enclose cylinder #1 tube structure 220 and cylinder #2 tube structure 245, any unabsorbed force may vent out of containment housing 201 through air blast vent 251 and away from an operator and/or bystanders.

SCBA cylinder 230 may be a pressurized cylinder and may comprise SCBA cylinder valve 225 that may allow for filling. Scuba tank 235 may be a pressurized cylinder and may comprise dip tube 240 and scuba tank valve 255 that may allow for filling with compressed fluid (typically, a gas). During a rupture or catastrophic failure of a pressurized cylinder, such as but not limited to, SCBA cylinder 230 or scuba tank 235, pressurized gas may be released, causing a proportionally contained force to be applied to surrounding areas and volumes as it expands. Expanding high-pressure gases, 650-7,000 pounds per square inch (“psi”), may create gas jets capable of causing incisions and damage to objects or operators in the surrounding area or volume. A rupture or catastrophic failure may cause a portion of SCBA cylinder valve 225, SCBA cylinder 230, scuba tank 235, dip tube 240, or scuba tank valve 255 to become projectiles as the pressurized gas expands.

Cylinder #1 tube structure 220 and cylinder #2 tube structure 245 may preferably be similar structures that are configured to matingly cradle and/or contain pressurized gas containers to be filled. Cylinder #1 tube structure 220 and cylinder #2 tube structure 245 may comprise an internal void volume formed by bonding one or more layers of composite materials. Cylinder #1 tube structure 220 and cylinder #2 tube structure 245 may include portions that are made from composite materials, such as plastic (most commonly polyethylene), fiber composites (fiberglass, para-aramid fibers, and the like), polyurethane-foamed aluminum, plywood, composite laminates, and Sorbothane® (synthetic viscoelastic urethane polymer). The composite materials of Cylinder #1 tube structure 220 and cylinder #2 tube structure 245 may preferably be constructed from materials and in a manner that allows them to structurally break down as they absorb the force from the expanding gas and or projectiles from a rupture or failure of a pressurized cylinder. Cylinder #1 tube structure 220 and cylinder #2 tube structure 245 may further comprise wound filament fibers, such as, but not limited to glass, carbon, and or aramid fibers. The wound filament fibers integrated into, onto, or around cylinder #1 tube structure 220 and cylinder #2 tube structure 245 may assist in absorbing the force of the expanding gas and/or shrapnel. Filament fibers are typically very strong and may have tensile strengths of up to 3,620 megapascals (“MPa”) or five times the strength of steel. Filament fiber may hold cylinder #1 tube structure 220 and cylinder #2 tube structure 245 together as cylinder #1 tube structure 220 and cylinder #2 tube structure 245 structurally break down while also absorbing and dissipating any force throughout the wound filament fiber. Cylinder #1 tube structure 220 and cylinder #2 tube structure 245 must do enough work to absorb the force from pressurized cylinder when it ruptures, so extending the time cylinder #1 tube structure 220 and cylinder #2 tube structure 245 absorb the force reduces the total unabsorbed force. Filament fiber windings may assist in prolonging the structural failure time of the composite materials of cylinder #1 tube structure 220 and cylinder #2 tube structure 245, which may maximize the absorbed force from the expanding gas and projectiles from a failure of pressurized cylinders, such as but not limited to SCBA cylinder 230 or Scuba tank 235. Cylinder #1 tube structure 220 and cylinder #2 tube structure 245 may allow any unabsorbed force to vent or escape cylinder #1 tube structure 220 and cylinder #2 tube structure 245 as a residual reduced force of a failed or ruptured pressurized cylinder, such as but not limited to SCBA cylinder 230 or Scuba tank 235.

Gas molecules typically expand farther from each other and spread out uniformly until they fill whatever container they may be in. Gas expansion volume 260 may be a volume that allows the residual reduced force of a failed or ruptured pressurized cylinder to expand evenly within the rupture-resistant containment fill station 200. This may allow for a reduced size and weight rupture-resistant containment fill station 200. Allowing the residual reduced force of a failed or ruptured pressurized cylinder to expand into volume 260 may provide for an even distribution residual reduced force of a failed or ruptured pressurized cylinder to the containment housing 201. Evenly distributing the residual reduced force of a failed or ruptured pressurized cylinder may allow for lighter materials in making the containment housing 201.

Although shown as having only two tube structures, cylinder #1 tube structure 220 and cylinder #2 tube structure 245, an alternative embodiment of fill station 200 may include various configurations with varying number of tube structures. Fill station 200 is not limited to any specific size or number of Cylinder #1 tube structure 220 and cylinder #2 tube structure 245.

Interior wall structure 210 may be made from a similar composite material as cylinder #1 tube structure 220 or cylinder #2 tube structure 245. It may be made from a material that may deform or crumple as it absorbs a projectile or a residual reduced force of a failed or ruptured pressurized cylinder. A material that may deform may comprise, but is not be limited to, metals (preferably thin and light), plastics, ceramics, fiberglass, wood, and aramid fiber materials.

As interior wall structure 210 deforms, it may transfer a portion of the residual reduced force of a failed or ruptured pressurized cylinder into crumple zone structure 215. Crumple zone structure 215 may preferably be a material that may crumple, compact, crush, or bend into irregular folds, shapes, wrinkles, or collapses as it absorbs a portion of the residual reduced force of a failed or ruptured pressurized cylinder. Crumple zone structure 215 may be made from, but not limited to, plastics, plastic composites, carbon fiber, honeycomb or corrugated cardboard, plywood, and energy-absorbing foam.

In an alternative embodiment crumple zone structure 215 may be a combination of materials in which a more force absorbing material is held up and away by standoffs (not shown) and allowed to deform into a stronger less energy absorbing material.

As crumple zone structure 215 absorbs a portion of the residual reduced force of a failed or ruptured pressurized cylinder, exterior wall structure 205 may preferably maintain the structural shape and integrity of containment housing 201. Containment housing 201 may be made from lightweight, strong materials such as but not limited to polycarbonate, acrylonitrile butadiene styrene (“ABS”), polyphenylsulfone (“PPSU”), ultra-high molecular weight polyethylene (“UHMW”), or thin and lightweight metal material.

A sufficiently strong and violent rupture or failure of one or more pressurized cylinders may have some unabsorbed expanding gas and force but typically does not include any projectiles or shrapnel. Any unabsorbed force and expanding gas may vent the rupture-resistant containment fill station 200 through opening structure 250.

Air blast vent 251 may be configured to vent any unabsorbed force of a rupture in a controlled manner. Air blast vent 251, in combination with cylinder #1 tube structure 220 or cylinder #2 tube structure 245, may control the venting of any unabsorbed force because the force may be partially obstructed by cylinder #1 tube structure 220 and/or cylinder #2 tube structure 245, and then redirected to exit though air blast vent 251. The combination of the unabsorbed force of a rupture being forced out through air blast vent 251 and being partially obstructed by structures 220, 245, increases the duration of time that containment housing 201 may absorb the force of the rupture, which allows more of the force of the rupture to be absorbed.

Opening structure 250 may be a panel or door that may be attached to cylinder #1 tube structure 220 and may be configured to direct any unabsorbed force away from an operator or bystanders and through air blast vent 251. Opening structure 250 may pivot with cylinder #1 structure 220. The combination of the unabsorbed force being directed out through smaller air blast vent 251 and partially obstructed increases the time containment housing 201 may absorb more force.

Rupture-resistant containment fill station 200 may preferably be oriented in such a manner that directs any expanding gas or force away from a fill operator. In alternate embodiment opening structure 250 may be a door that opens, closes, and/or allows access to the internal structure and contents of rupture-resistant containment fill station 200.

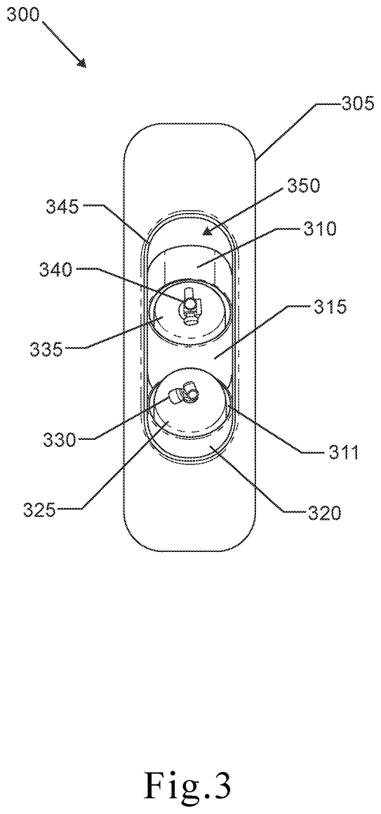

FIG. 3 is an illustration of a front view of one embodiment of the rupture-resistant containment fill station. FIG. 3 shows the cylinders being tipped so they can be loaded or unloaded into fill station 300. In this configuration, gas expansion volume 350 may allow cylinder #1 tube structure 315 and cylinder #2 tube structure 320 to rotate about a pivot point (not shown) and allow for installation and removal of pressurized cylinders such as but not limited to SCBA cylinder 335 and scuba tank 325. Containment housing 305 may preferably provide structural stability and support for the rupture-resistant containment fill station 300. It is preferable to have cylinder #1 tube structure 315 and cylinder #2 tube structure 320 rotate to allow installation and removal of pressurized cylinders, such as but not limited to SCBA cylinder 335 and scuba tank 325 from opening structure 345 into first internal void volume 310 and second internal void volume 311. In addition, scuba tank valve 330 and SCBA cylinder valve 340 may be available to a filler operator to connect and disconnect filling accessories (not shown).

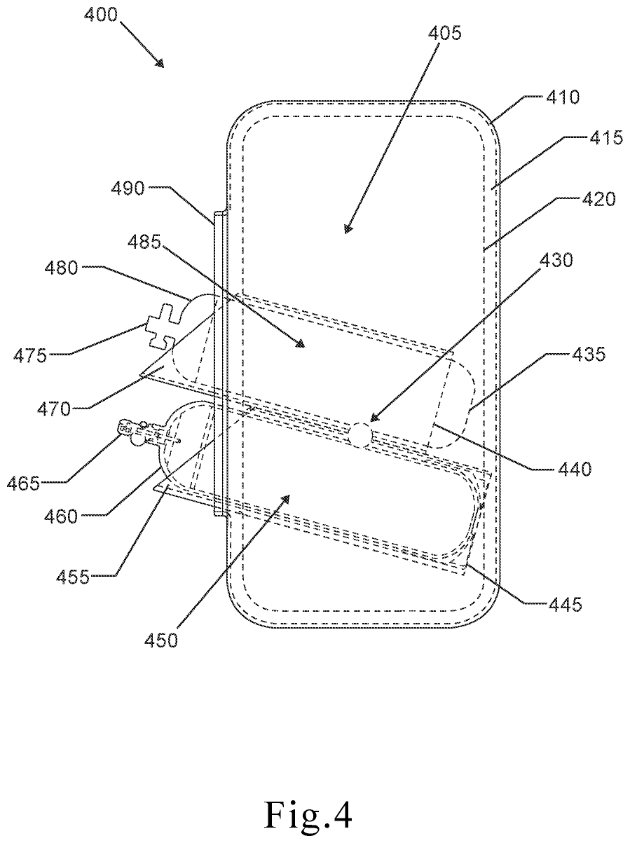

FIG. 4 is an illustration of side view of one embodiment of the rupture-resistant containment fill station. Pivot point 430 may be a hinge or rotational structure that preferably allows cylinder #1 tube structure 485 and cylinder #2 tube structure 450 to rotate and expose first internal void volume 470 and second internal void volume 455 for installation and removal of SCBA cylinder 480 or scuba tank 460 from a rupture-resistant containment fill station 400. In this configuration, SCBA cylinder valve 475 or scuba tank valve 465 may be connected and disconnected to filling accessories (not shown). Preferably, the pivot point 430 is connected to structures 485, 450, as shown in FIG. 4, that the user is able to tilt the compressed tanks 460, 480, with minimal physical effort due to weight balancing. Further, as shown in FIG. 4, opening structure 490 is preferably sized to allow both tanks 460, 480 to be either entirely contained within fill station 400 or are accessible for loading, unloading, and/or manipulation of the valves 465, 475.

Bottom opening of cylinder #1 tube structure 440 may be an opening in the bottom of cylinder #1 tube structure 485 but should not be limited to cylinder tube #1 tube structure 485. SCBA cylinder bottom 435 may protrude from bottom opening of cylinder #1 tube structure 440. Bottom opening of cylinder #1 tube structure 440 may allow a force and expanding gas from a failure or rupture of a pressurized cylinder, such as but not limited to SCBA cylinder 480, to expand into the bottom portion of gas expansion volume 405. Bottom opening of cylinder #1 tube structure 440 may allow a force and expanding gas to be more evenly distributed throughout gas expansion volume 405.

Bottom closure of cylinder #2 tube structure 445 may direct a force and expanding gas from a failure or rupture of a pressurized cylinder, such as but not limited to scuba tank 460, into the top portion of gas expansion volume 405. Bottom closure of cylinder #2 tube structure 445 should not be limited to cylinder #2 tube structure 450. This may allow cylinder #2 tube structure 450 to absorb a greater amount of force from the expanding gas from a failed or ruptured pressurized cylinder.

As shown in FIG. 4, opening structure 490 may allow internal wall structure 420 to be inspected for any deforming or damage that may also indicate crumple zone structure 415 may or may not have been damaged. Exterior wall structure 410 may preferably be configured to support the pivot point 430 through the internal wall structure 420 and crumple zone structure 415.

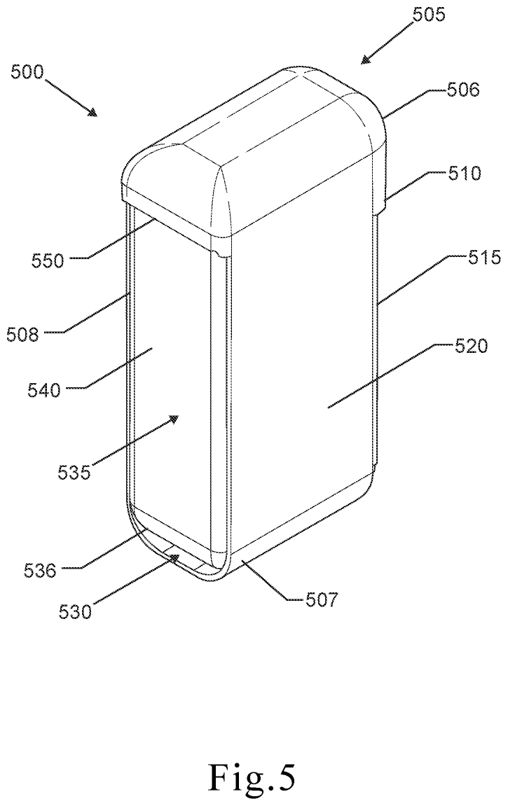

FIG. 5 is an illustration of a perspective view of another embodiment of a rupture-resistant containment fill station. Rupture-resistant containment fill station 500 may comprise containment housing 505, right side containment housing shroud 510, containment housing front 520, bottom containment housing tilt void 530, impact absorbing insert (“IAI”) 535, and lip 550.

IAI 535 may further comprise right side of IAI 515, bottom of IAI 536, left side of IAI 540, and rear side of IAI (not shown). Containment housing 505 may preferably be constructed to substantially support the internal structures, features, and accessories needed to successfully fill compressed gas containers. Bottom containment housing tilt void 530 may be configured to allow installation of IAI 535 into housing 505 and allow any force due to a rupture not absorbed internally to escape without compromising the containment housing 505. Preferably, containment housing 505 may be constructed using lightweight and strong materials, such as thinned steel plating or reinforcement, aluminum, and/or composite materials, but it may be made from any suitable material that provides strength and lightweight. The strength of a material may be compromised when manufactured using thinner dimensions, so care must be taken to place thicker plating or stronger composite materials in places where strength is needed the most.

In various embodiments, containment housing 505 may be a single unit or may be constructed from multiple portions, as preferred. Containment housing 505, containment housing top 506, right side containment housing shroud 510, containment housing bottom 507, lip 550, and containment housing rear 508 may be made using injection mold techniques, welding metals, or being formed via other known manufacturing techniques. As shown in FIG. 5, rupture-resistant containment fill station 500 may generally be a rounded rectangular shape. It should be understood that rupture-resistant containment fill station 500 may be any shape, including, but not limited to, square, hexagonal, or other geometric shape, or cylindrical.

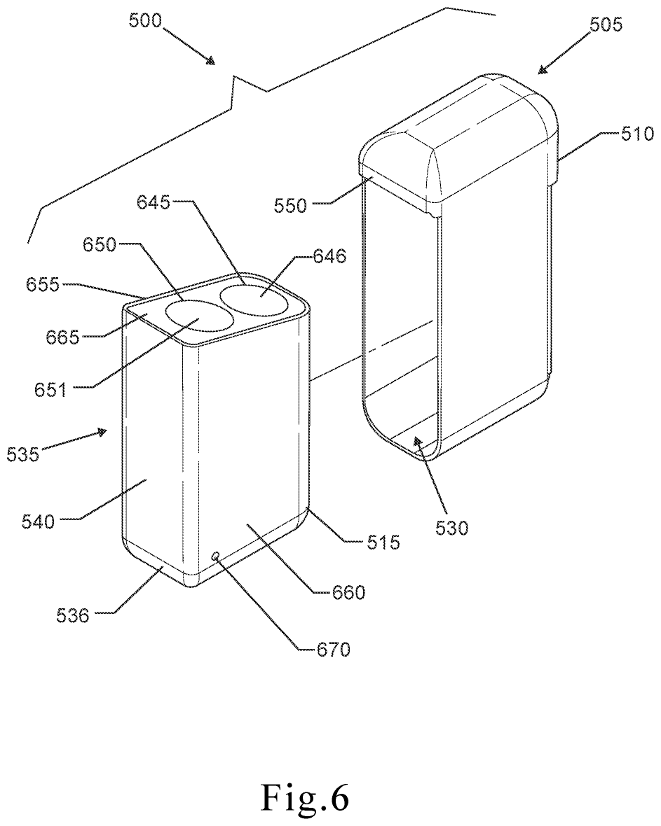

FIG. 6 is an illustration of an exploded view of another embodiment of a rupture-resistant containment fill station. Rupture-resistant containment fill station 500 may comprise containment housing 505 and impact-absorbing insert 535. As shown in FIG. 6, IAI 535 may be removed from containment housing 505. IAI 535 may comprise cylinder #1 tube structure 645, cylinder #2 tube structure 650, internal void volume 646, internal void volume 651, crumple zone structure 665, and pivot point 670.

Cylinder #1 tube structure 645 and cylinder #2 tube structure 650 may comprise one or more internal void volumes 646 and 651 to accept and retain pressurized cylinders. Preferably, cylinder #1 tube structure 645 and cylinder #2 tube structure 650 may include one or more layers of composite materials. The composite materials of Cylinder #1 tube structure 645 and cylinder #2 tube structure 650 may be made from, but are not limited to, such as plastic (most commonly polyethylene), fiber composites (fiberglass, para-aramid fibers, and the like), polyurethane-foamed aluminum, plywood, composite laminates, and Sorbothane® (synthetic viscoelastic urethane polymer). The composite materials of Cylinder #1 tube structure 645 and cylinder #2 tube structure 650 may preferably be constructed from materials and be constructed in such a manner that allows them to structurally break down as they absorb the force from the expanding gas and/or projectiles from a rupture or failure of a pressurized cylinder contained within said structures 645, 650. Cylinder #1 tube structure 645 and cylinder #2 tube structure 650 may further be made with wound filament fibers, such as, but not limited to, glass, carbon, and/or aramid fibers. The wound fibers of cylinder #1 tube structure 645 and cylinder #2 tube structure 650 may assist in absorbing the force of the expanding gas. Filament fiber windings may assist in prolonging the structural failure time of the composite materials of cylinder #1 tube structure 645 and cylinder #2 tube structure 650, which may maximize the absorbed force from the expanding gas and projectiles from a failure of pressurized. Cylinder #1 tube structure 645 and cylinder #2 tube structure 650 may allow any unabsorbed force to escape cylinder #1 tube structure 645 and cylinder #2 tube structure 650 as residual reduced force of a failed or ruptured pressurized cylinder.

Any residual reduced force of a failed or ruptured pressurized cylinder, such as expanding gas or projectiles, may mechanically transfer from cylinder #1 tube structure 645 and cylinder #2 tube structure 650 into crumple zone structure 665. Any unabsorbed expanding gas may vent or escape through containment housing 505 through right side containment housing shroud 510 and left side containment housing lip 550 and directed away from an operator or bystanders.

As cylinder #1 tube structure 645 and cylinder #2 tube structure 650 transfer residual reduced force of a failed or ruptured pressurized cylinder to crumple zone structure 665, crumple zone structure 665 may crumple, compact, crush, or bend into irregular folds, shapes, wrinkles, or collapse. Crumple zone structure 665 may be made from, but is not limited to, plastics, plastic composites, carbon fiber, honeycomb or corrugated cardboard, plywood, and energy-absorbing foam.

A sufficiently strong and violent rupture or failure of one or more pressurized cylinders when contained within IAI 535, may have some unabsorbed expanding gas and projectiles. Any unabsorbed force and expanding gas and projectiles may be mechanically transferred and absorbed by housing 505, which matingly contains IAI 535.

IAI 535, using similar methods and techniques as described hereinabove for Cylinder #1 tube structure 645 and cylinder #2 tube structure 650, may further absorb a force from the expanding gas and projectiles of a failed or ruptured pressurized cylinder. As shown, IAI 535 may comprise right side IAI 515, front side IAI 660, rear side IAI 655, bottom IAI 536, and left side IAI 540. In various embodiments, IAI 535 may be a single unit or, as preferred, may be constructed from multiple portions, including one or more crumple zones. IAI 535 may be made from composite materials, polycarbonate, acrylonitrile butadiene styrene (“ABS”), polyphenylsulfone (“PPSU”), ultra-high molecular weight polyethylene (“UHMW”), or thin and lightweight metal material. IAI 535, right side IAI 515, front side IAI 660, rear side IAI 655, bottom IAI 536, and left side IAI 540 may be made using injection mold techniques, welding metals, composite molding, or being formed via other known manufacturing techniques.

As shown in FIG. 6, IAI 535 may generally be a rounded rectangular shape. It should be understood that IAI 535 may be any shape, including, but not limited to, square, hexagonal, or other geometric shape, or cylindrical.

Pivot point 670 may be a wheel, bearing, or solid structure such as a bar or cylinder protruding from the front side IAI 660 and the rear side IAI 655. Pivot point 670 may allow IAI 535 to either pivot out of containment housing 505 or slide out of containment housing 505. Bottom containment housing tilt void 530 may be a space, void, or volume that allows IAI 535 to tilt out of containment housing 505 in an unobstructed manner.

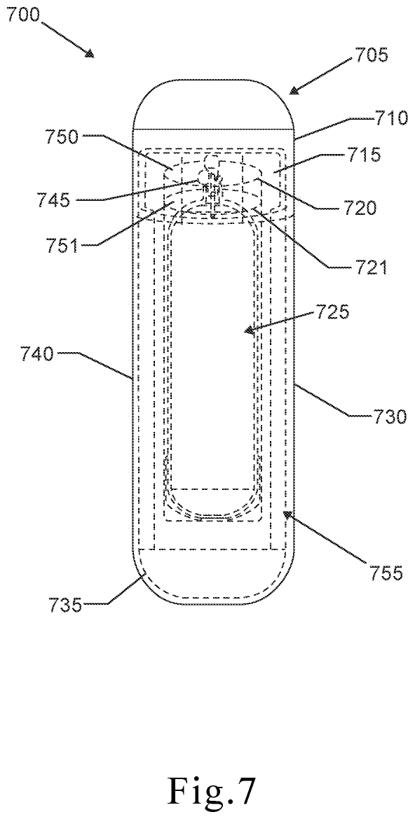

FIG. 7 is an illustration of another embodiment of the rupture-resistant containment fill station. In this configuration, rupture-resistant containment fill station 700 may allow a fill operator to fill pressurized cylinder 725. Pressurized cylinder 725 may be retained in void volume 750 of cylinder #1 tube structure 720 or void volume 751 of cylinder #2 tube structure 721. Pressurized cylinder 725 may be filled through the pressurized cylinder valve 745. Housing containment 705, in combination with front side containment housing 730 and rear side containment housing 740, may provide the structural support to house and retain impact-absorbing insert (“IAI”) 755 and associated filling accessories. Left side containment housing lip 710 may provide an engagement portion or stop for IAI 755 and allow IAI 755 to rest within containment housing 705 securely and in a balanced manner.

Containment housing 705 preferably and substantially encloses cylinder #1 tube structure 720 and cylinder #2 tube structure 721, as shown in FIG. 7, such that most force from a pressurized cylinder is absorbed when a pressurized cylinder ruptures. While cylinder #1 tube structure 720 and cylinder #2 tube structure 721 are substantially enclosed pressurized cylinders may be filled, as shown in FIG. 7, which may also be referred to as the filling position.

Because containment housing 705 substantially encloses cylinder #1 tube structure 720 and cylinder #2 tube structure 721 and does not completely enclose cylinder #1 tube structure 720 and cylinder #2 tube structure 721, any unabsorbed force may vent out of containment housing 705 away from an operator or bystander through containment housing shroud as shown in FIG. 5.

Crumple zone structure 715 may surround cylinder #1 tube structure 720 and cylinder #2 tube structure 721, as shown in FIG. 7.

Bottom containment tilt void 735 may be a void in this configuration and also allow for any unabsorbed expanding gas to vent into.

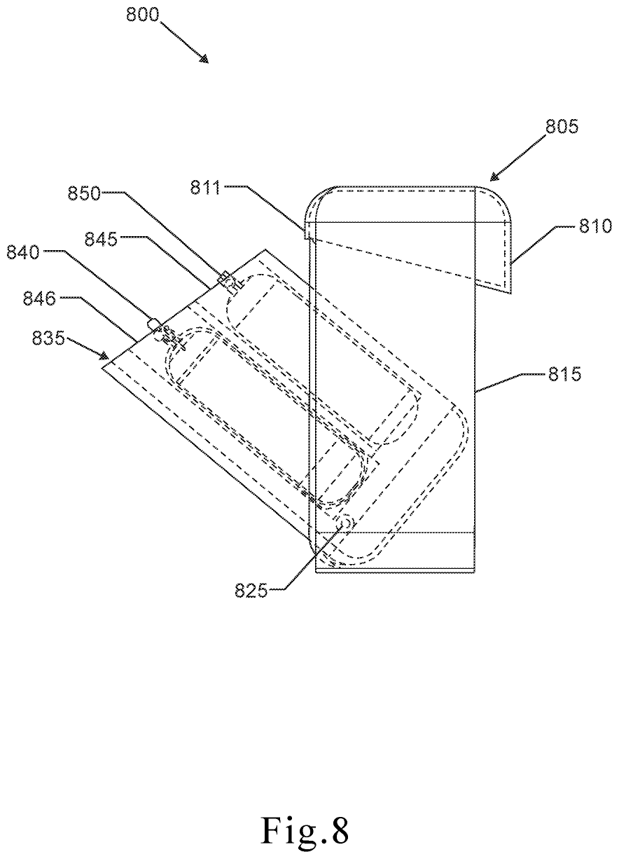

FIG. 8 is an illustration of a side view of another embodiment of the rupture-resistant containment fill station. In this configuration, rupture-resistant containment fill station 800 may allow a filling operator to tilt impact-absorbing insert (“IAI”) 835 out of containment housing 805 and install or remove pressurized fluid cylinders 840, 850. When the cylinders 840, 850 are loaded and any fill equipment is connected, the containment housing 805 accepts IAI 835 when tilted back up and the right side containment housing shroud 810 and left side containment housing lip 811 both may come into contact with the top of IAI 835.

Pivot point 825, which may comprise a pivot rod or other pivot mechanism, may be supported by front side containment housing 815. Pivot point 825 may allow IAI 835 to pivot away from, and at least partially out of, containment housing 805. While IAI 835 is pivoted away from containment housing 805, as referred to as loading position, pressurized cylinders may be accessible for removal after filling or installation for filling.

Void volume 845 and void volume 846 may allow pressurized cylinder 840 and pressurized cylinder 850 to be connected and disconnected for filling operation or removal.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A lightweight high pressure cylinder containment fill station comprising:
a containment housing; and
one or more cylinder tubes;
wherein said containment housing is configured to substantially enclose said one or more cylinder tubes;
wherein said one or more cylinder tubes comprise composite materials;
wherein each of said one or more cylinder tubes are configured to retain a pressurized cylinder;
wherein each of said one or more cylinder tubes are configured to substantially absorb a force from said pressurized cylinder when said pressurized cylinder ruptures;
wherein an unabsorbed force, from when said pressurized cylinder ruptures, vents out of said one or more cylinder tubes as a residual reduced force; and
wherein said containment housing is configured to substantially absorb and retain said residual reduced force.

2. The fill station of claim 1, wherein said containment housing comprises a metal material and composite materials.

3. The fill station of claim 1, wherein said containment housing and said one or more cylinder tubes are made from materials selected from the group of materials consisting of one or more of: composite materials; plastics; polyethylene; polycarbonate; acrylonitrile butadiene styrene polyphenylsulfone; ultra-high molecular weight polyethylene; thin and lightweight metal materials; heavy metal materials; fiber composites; fiberglass; aramid fibers; para-aramid fibers; polyurethane-foamed aluminum; plywood, composite laminates; and synthetic viscoelastic urethane polymer.

4. The fill station of claim 1, further comprising a pivot point;
wherein said one or more cylinder tubes are configured to rotate about said pivot point, such that said one or more cylinder tubes have an enclosed position and a loading position; and
wherein said one or more cylinder tubes are configured to accept installation of said pressurized cylinders, when said one or more cylinder tubes are in said loading position.

5. The fill station of claim 1, wherein said one or more cylinder tubes are configured to structurally breakdown while absorbing said force from said pressurized cylinder when said pressurized cylinder ruptures.

6. The fill station of claim 1, wherein each of said one or more cylinder tubes further comprises:
one or more filament fibers;
wherein said one or more filament fibers are wound around said composite materials of each of said one or more cylinder tubes.

7. The fill station of claim 6,
wherein said one or more filament fibers are selected from the group of filament fibers consisting of: glass; carbon; aramid; and combinations thereof.

8. The fill station of claim 1, wherein said containment housing further comprises:
one or more a crumple zone structures; and
wherein said one or more crumple zone structures are configured to deform as they absorb any portion of said residual reduced force from said pressurized cylinder when said pressurized cylinder ruptures.

9. The fill station of claim 4, wherein said containment housing further comprises:
a pressurized cylinder installation opening;
wherein when said one or more cylinder tubes are in said loading position, said one or more cylinder tubes are configured to be accessible through said pressurized cylinder installation opening.

10. The fill station of claim 9, wherein said pressurized cylinder installation opening is configured to allow any unabsorbed residual reduce force of said ruptured pressurized cylinder to vent in a controlled manner out of said containment housing.

11. The fill station of claim 8, wherein each of said one or more crumple zone structures comprise one or more materials selected from the group of materials consisting of: plastics; plastic composites; carbon fiber; honeycomb or corrugated cardboard; plywood; and energy-absorbing foam.

12. A lightweight high pressure cylinder containment fill station comprising:
a containment housing;
a pivot point; and
one or more cylinder tubes;
wherein said containment housing is configured to substantially enclose said one or more cylinder tubes;
wherein said one or more cylinder tubes comprise composite materials;
wherein each of said one or more cylinder tubes are configured to retain a pressurized cylinder;
wherein each of said one or more cylinder tubes are configured to substantially absorb a force from said pressurized cylinder when said pressurized cylinder ruptures;
wherein an unabsorbed force, from when said pressurized cylinder ruptures, vents out of said one or more cylinder tubes as a residual reduced force;
wherein said containment housing is configured to substantially absorb and retain said residual reduced force;
wherein said one or more cylinder tubes are configured to rotate about said pivot point, such that said one or more cylinder tubes have an enclosed position and a loading position; and
wherein said one or more cylinder tubes are configured to accept installation of said pressurized cylinders, when said one or more cylinder tubes are in said loading position.

13. The fill station of claim 12, wherein said containment housing and said one or more cylinder tubes are made from materials selected from the group of materials consisting of one or more of: composite materials; plastics; polyethylene; polycarbonate; acrylonitrile butadiene styrene polyphenylsulfone; ultra-high molecular weight polyethylene; thin and lightweight metal materials; heavy metal materials; fiber composites; fiberglass; aramid fibers; para-aramid fibers; polyurethane-foamed aluminum; plywood, composite laminates; and synthetic viscoelastic urethane polymer.

14. The fill station of claim 13, wherein said one or more cylinder tubes are configured to structurally breakdown while absorbing said force from said pressurized cylinder when said pressurized cylinder ruptures.

15. The fill station of claim 13, wherein each of said one or more cylinder tubes further comprises:
one or more filament fibers;
wherein said one or more filament fibers are wound around said composite materials of each of said one or more cylinder tubes; and
wherein said one or more filament fibers are selected from the group of filament fibers consisting of: glass; carbon; aramid; and combinations thereof.

16. The fill station of claim 13, wherein said containment housing further comprises:
one or more a crumple zone structures; and
wherein said one or more crumple zone structures are configured to deform as they absorb any portion of said residual reduced force from said pressurized cylinder when said pressurized cylinder ruptures; and
wherein each of said one or more crumple zone structures comprise one or more materials selected from the group of materials consisting of: plastics; plastic composites; carbon fiber; honeycomb or corrugated cardboard; plywood; and energy-absorbing foam.

17. The fill station of claim 16, wherein said containment housing further comprises:
a pressurized cylinder installation opening;
wherein when said one or more cylinder tubes are in said loading position, said one or more cylinder tubes are configured to be accessible through said pressurized cylinder installation opening; and
wherein said pressurized cylinder installation opening is configured to allow any unabsorbed residual reduce force of said ruptured pressurized cylinder to vent in a controlled manner out of said containment housing.

18. A lightweight high pressure cylinder containment fill station comprising:
a containment housing;
an impact absorbing insert (“IAI”);
wherein said containment housing is configured to substantially enclose said IAI;
wherein said IAI comprises composite materials;
wherein said IAI is configured to retain at least one pressurized cylinder;
wherein said IAI is configured to substantially absorb a force from said at least one pressurized cylinder when said pressurized cylinder ruptures;
wherein an unabsorbed force, from when said at least one pressurized cylinder ruptures, vents out of said IAI as a residual reduced force; and
wherein said containment housing is configured to substantially absorb and retain said residual reduced force.

19. The fill station of claim 18, wherein said IAI may be at least partially removed from said containment housing, such that said IAI has an enclosed position and a loading position; and
wherein said IAI is configured to accept installation of said at least one pressurized cylinder, when said IAI is in said loading position.

20. The fill station of claim 19, wherein said IAI is configured to structurally breakdown while absorbing said force from said at least one pressurized cylinder when said at least one pressurized cylinder ruptures;
wherein said IAI further comprises one or more filament fibers;
wherein said one or more filament fibers are wound around said composite materials of said IAI;
wherein said one or more filament fibers are selected from the group of filament fibers consisting of: glass; carbon; aramid; and combinations thereof;
wherein said containment housing further comprises one or more a crumple zone structures;
wherein said one or more crumple zone structures are configured to deform as they absorb any portion of said residual reduced force from said at least one pressurized cylinder when said at least one pressurized cylinder ruptures; and
wherein each of said one or more crumple zone structures comprise one or more materials selected from the group of materials consisting of: plastics; plastic composites; carbon fiber; honeycomb or corrugated cardboard; plywood; and energy-absorbing foam.
